(19) United States
(12) Patent Application Publication
(10) Pub. No.: US 2009/0100242 A1
(43) Pub. Date: Apr. 16, 2009

(54) Data Processing Method for Use in Embedded System

(75) Inventors: Han Chi Lin, Hsinchu Hsien (TW); Chung Li Yang, Hsinchu Hsien (TW)

Correspondence Address: WPAT, PC, 7225 BEVERLY ST., ANNANDALE, VA, 22003, US

(73) Assignee: MSTAR SEMICONDUCTOR, INC., Hsinchu Hsien (TW)

(21) Appl. No.: 12/242,083

(22) Filed: Sep. 30, 2008

(30) Foreign Application Priority Data
Oct. 15, 2007 (TW) 096138405

(51) Int. Cl. G06F 12/02

(52) U.S. Cl. 711/165; 711/E12.002

(57) ABSTRACT

A data processing method for an embedded system is provided. The embedded system includes a first processor, a second processor, a nonvolatile memory, and a volatile memory. The data processing method includes steps of initiating data transfer of compressed data from the nonvolatile memory to the volatile memory by the first processor, and decompressing the compressed data in the volatile memory by the second processor; and further writing the decompressed data to the volatile memory by the second processor.

### FIELD OF THE INVENTION

The present invention relates to a data processing method, and more particularly to a data processing method for use in an embedded system.

### BACKGROUND OF THE INVENTION

Embedded systems are developed on demand of industrial computers, and become widespread along with computer information products, communication products and digital household appliances. From new-generation digital televisions and mobile phones to portable devices such as digital cameras and personal digital assistants, embedded systems are applied therein. Embedded systems are capable of performing functions on small-area components, with characteristics of being reliable, small in size as well as having large application flexibilities.

FIG. 1 shows a functional block diagram of a digital television. A tuner 102 receives television signals from a television signal source 101. The television signals are processed by a demodulator 103 and a demultiplexer 104 to obtain data to be further processed and decoded by a digital signal processor (DSP) 111, a video decoder 112 and a data decoder 113. Audio data is played on a speaker 131, and video data is processed by a graphics processor 121 and then displayed on a display 132.

Other information in the received television signals is decoded by the data decoder 113, and forwarded to a central processing unit (CPU) 122 for further processing. Command information sent by a user operating a user interface 140, e.g. a remote control 141 or buttons 142 on the digital television, is also processed by the central processing unit 122 and then stored in a memory device 150. The memory device 150 usually includes a dynamic random access memory (DRAM) 151 and a flash memory 152.

However, the embedded system, e.g. in the digital television described above, is given with limited resources, especially cost-wise resources. In addition, due to the DRAM 151 and flash memory 152 being limited with certain capacities, system programmers need to compress graphic files, data of fonts in various languages or codes before storing into the embedded system to save storage space. Yet, computation capability of the CPU 122 in the embedded system is limited. Users may conceive the speed of the embedded system is rather slow due to data decompression.

For the foregoing reasons, there is a need to provide a method for solving the shortcoming of the prior art under the circumstances of limited hardware resources.

### SUMMARY OF THE INVENTION

Therefore, the present invention discloses a data processing method for use in an embedded system, which at least has a first processor, a second processor, a nonvolatile memory, and a volatile memory.

The data processing method according to the present invention comprises steps of initiating transfer of compressed data from the nonvolatile memory to the volatile memory by the first processor; and the second processor decompressing the compressed data stored to the volatile memory to produce decompressed data, and writing the decompressed data to the volatile memory. The data transfer may be completed by direct access memory (DMA) transfer, and the embedded system may be a television chipset or a mobile phone chipset.

The data processing method according to the invention further comprises steps of providing the embedded system with a first register and a second register; writing a request for compressed data into the second register by the second processor; periodically reading contents in the second register to initiate data transfer by the first processor, and writing a reading parameter to the first register by the first processor when data transfer is completed, wherein the reading parameter including information associated with address and size of the compressed data in the volatile memory; and periodically reading contents of the first register for reading and decompressing the compressed data stored in the volatile memory by the second processor based on the reading parameter, and further writing the decompressed data to the volatile memory by the second processor. The second processor ends data decompression in response to an ending code in the compressed data. The second processor can be an audio DSP. An audio processing program code is loaded and executed to allow the audio DSP to continue audio processing.

### BRIEF DESCRIPTION OF THE DRAWINGS

The present invention will become more readily apparent to those ordinarily skilled in the art after reviewing the following detailed description and accompanying drawings, in which:

FIG. 1 is a functional block diagram of a prior digital television.

FIG. 2 is an internal functional block diagram of an embedded system according to a preferred embodiment of the invention.

FIGS. 3(a) and 3(b) show a flow chart of a data processing method for processing compressed data according to a preferred embodiment of the invention.

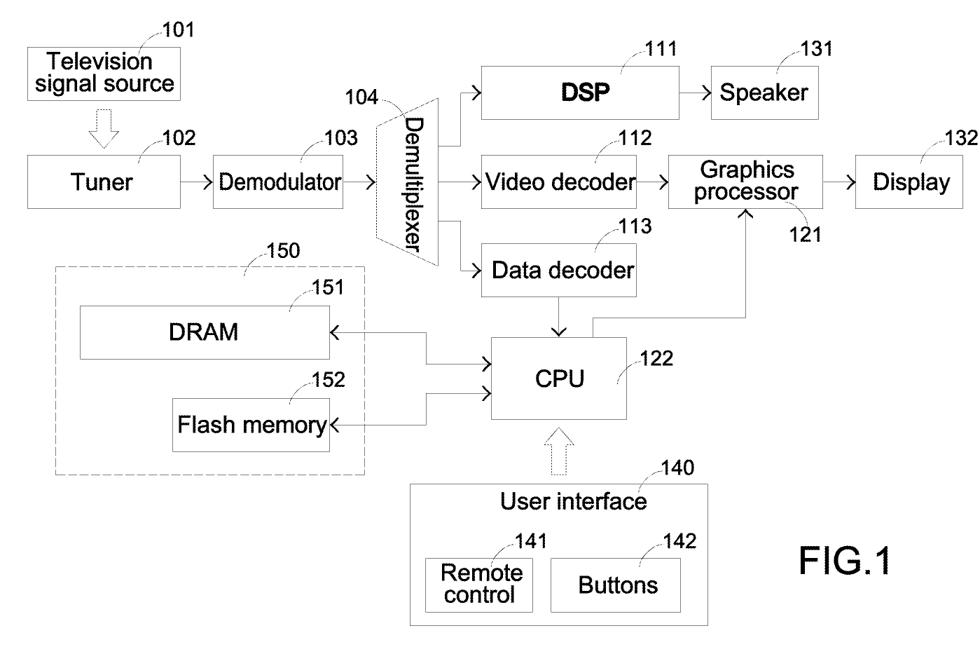

### DETAILED DESCRIPTION OF THE PREFERRED EMBODIMENT

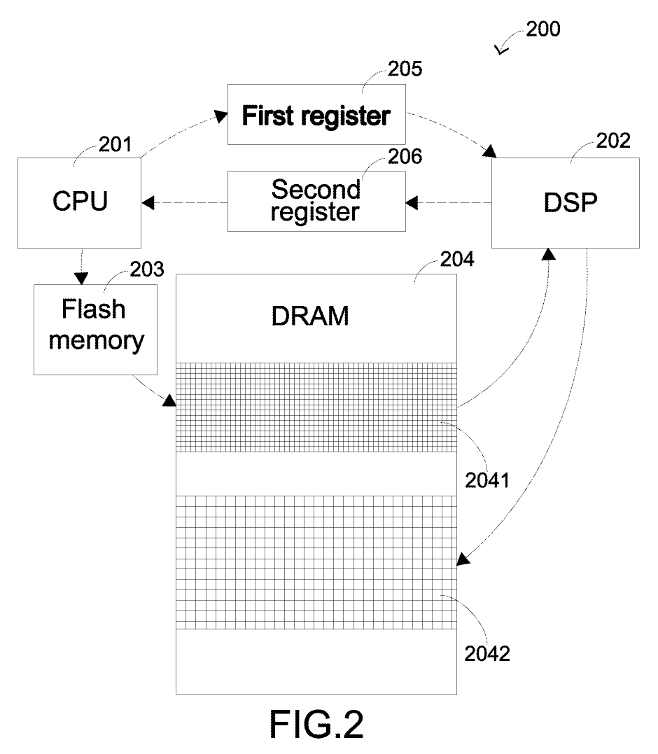

Referring to FIG. 2 showing an internal functional block diagram of an embedded system 200 according to a preferred embodiment of the invention, the embedded system 200 comprises a central processing unit 201 and a DSP 202 for handling different tasks. For example, the embedded system 200 can be applied to a television system, a mobile phone, or any electronic device with an embedded system. One of the primary objects of the invention is to effectively improve system power-on time with limited hardware resources.

After examining the system power-on procedure, it is observed that the DSP 202, for example, for handling audio decoding is idle most of the time during system power-on, which is conducted by the central processing unit 201.

First of all, when entering the system power-on procedure, the central processing unit 201 notifies the DSP 202 to load and execute a decompression program code to provide the DSP 202 with decompression capability. The DSP 202 then writes a request for compressed data in a second register 206, while the central processing unit 201 periodically reads contents in the second register 206. Upon the central processor unit 201 reads the compressed data request, the central processing unit 201 initiates data transferring of compressed data stored in the flash memory 203 to a first predetermined area 2041 of the DRAM 204, and writes a reading parameter into a first register 205 when the transfer process is completed. The reading parameter includes information associated with address and size of the compressed data in the DRAM 204. When reading the presence of the reading parameter in the first register, the DSP 202 reads the compressed data stored in the DRAM 204 with reference to the address and size information to carry out data decompression, and writes the decompressed data to a second predetermined area 2042 of the DRAM 204. For example, the decompression performed by the DSP 202 may be an LZSS decompression algorithm. When an ending code is read from the compressed data during the process of reading and decompression, it represents that the reading of the compressed data is completed, and the process of reading and then decompression can be terminated. Subsequently, the DSP 202 may load and execute, for example, an audio processing program code to allow the DSP 202 to continue audio processing also requested by the system.

On the other hand, provided that the DSP 202 has not yet read the ending code, the DSP 202 may carry on with writing a request for compressed data to the second register 206 in the embedded system 200, so that the central processing unit 201 keeps initiating data transfer for continually moving and storing the compressed data from the flash memory 203 to the first predetermined area 2041 of the DRAM 204 for the DSP 202 to further decompress additional compressed data. When the decompressed data written on the DRAM 204 is about to exceed the capacity of the second predetermined area 2042, the central processing unit 201 transfers the data in the second predetermined area 2042 to another area of the DRAM 204, such that the capacity of the second area 2042 becomes available for storing newly decompressed data.

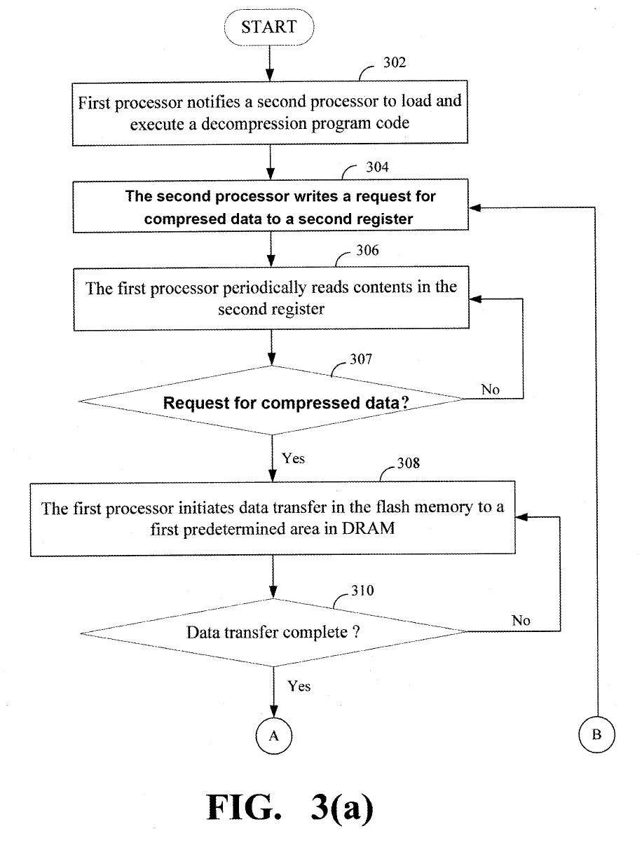

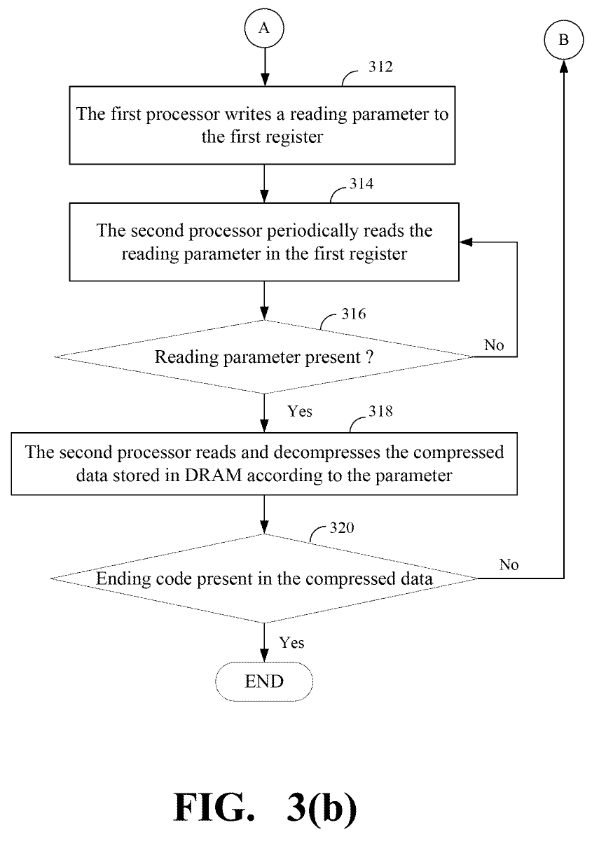

Therefore, FIGS. 3(a) and 3(b) show a flow chart of a data processing method for processing compressed data according to an embodiment of the invention. At step 302, a first processor notifies a second processor to load and execute a decompression program code to provide the second processor with decompression capability. At step 304, the second processor writes a request for compressed data in a second register. At step 306, the first processor periodically accesses the second register to read any contents in the second register. If a request for compressed data is read at step 307, proceeds to step 308; if not, returns back to step 306. At step 308, the first processor initiates data transfer from the flash memory to a first predetermined area in DRAM. If the data transfer is completed at step 310, proceeds to step 312 in FIG. 3(b); if not, returns back to step 308. At step 312, the first processor writes a reading parameter in the first register. At step 314, the second processor periodically accesses the first register to read any reading parameter in the first register. If a reading parameter is read in step 316, proceeds to step 318; if not, returns back to step 314. At step 318, the second processor reads and decompresses the compressed data stored in DRAM according to the reading parameter obtained from the first register. The reading parameter includes information associated with address and size of the compressed data in DRAM. The step 320 determines whether an ending code is present in the compressed data, and terminates the process if the ending code is present.

To sum up, the present invention may be applied in a power-on procedure of an embedded system 200 having at least two processors, e.g. a television chipset, a mobile phone chipset, or any electronic device with embedded procedures. The first processor for loading compressed data from the nonvolatile memory to the volatile memory may be a main processor 201 of the embedded system 200. The second processor for decompressing data may be a DSP 202 commonly seen in the embedded system 200. During initiation process of data transfer, such as direct memory access (DMA) transfer, by the first processor, other steps of system power-on procedure are simultaneously performed, thereby effectively shortening time for system power-on without requiring high-performance and costly microprocessors. Take a digital television chip for instance, as disclosed by above embodiment, an 8051 processor can be applied as the first processor to satisfy system requirements instead of applying high-end processors such as MIPS or ARM processors. The flash memory 203 may be accomplished by various nonvolatile memories, and the DRAM 204 may be accomplished by various volatile memories. The first register 205 and second register 206 may be implemented by two predetermined areas in the DRAM 204, given that the predetermined areas provide communication between at least two processors for reading data and writing data.

While the invention has been described in terms of what is presently considered to be the most practical and preferred embodiments, it is to be understood that the invention needs not to be limited to the above embodiments. On the contrary, it is intended to cover various modifications and similar arrangements included within the spirit and scope of the appended claims which are to be accorded with the broadest interpretation so as to encompass all such modifications and similar structures.

What is claimed is:

1. A data processing method for use in an embedded system having a first processor, a second processor, a first memory storage, and a second memory storage, comprising steps of:
initiating data transfer of compressed data from the first memory storage to the second memory storage under control of the first processor;
decompressing the compressed data to produce decompressed data under control of the second processor; and
storing the decompressed data in the second memory storage.

2. The data processing method according to claim 1, wherein the embedded system is a television chipset or a mobile phone chipset.

3. The data processing method according to claim 1, wherein the first processor, the second processor, the first memory storage, and the second memory storage of the embedded system are a microprocessor, a digital signal processor (DSP), a flash memory, and a dynamic random access memory (DRAM), respectively.

4. The data processing method according to claim 1, wherein the first processor initiates data transfer during a system power-on procedure, and performs other steps of the system power-on procedure after initiating data transfer.

5. The data processing method according to claim 1, wherein the data transfer is a direct memory access (DMA) transfer.

6. The data processing method according to claim 1 further comprising steps of:
providing a third memory storage and a forth memory storage in the embedded system;
writing a request for compressed data in the forth memory storage by the second processor;
periodically reading contents in the forth memory storage for initiating data transfer by the first processor in response to the request for compressed data, and writing a reading parameter into the third memory storage by the first processor when the data transfer is completed; and
periodically reading the reading parameter in the third memory storage by the second processor, and reading and decompressing the compressed data stored in the second memory storage according to the reading parameter, and writing the decompressed data into the second memory storage by the second processor.

7. The data processing method according to claim 6, wherein the reading parameter associates with address and size of the compressed data in the second memory storage.

8. The data processing method according to claim 6, wherein the second processor ends data decompression in response to an ending code present in the compressed data.

9. The data processing method according to claim 6 further comprising steps of:
notifying the second processor to load and execute a decompression program code by the first processor, wherein the decompression program code provides the second processor with decompression capability.

10. The data processing method according to claim 1, wherein the data decompression carried out by the second processor is an LZSS data compression algorithm.

11. The data processing method according to claim 1, wherein the second processor is an audio digital signal processor (DSP).

12. The data processing method according to claim 11, further comprising loading and executing an audio processing program code to allow the audio DSP to continue audio processing.
